(19) United States
(12) Patent Application Publication
(10) Pub. No.: US 2018/0094173 A1
(43) Pub. Date: Apr. 5, 2018

(54) LOW MOISTURE ABSORBING OPTICALLY CLEAR ADHESIVE FOR A METALLIC CONDUCTOR

(71) Applicant: 3M INNOVATIVE PROPERTIES COMPANY, St. Paul, MN (US)

(72) Inventors: Albert I. Everaerts, Tucson (AZ); Chun-Yi Ting, Taoyuan Hsien (TW); Jianhui Xia, Woodbury, MN (US); Lili Qie, Woodbury, MN (US)

(21) Appl. No.: 15/569,667

(22) PCT Filed: Apr. 27, 2016
(86) PCT No.: PCT/US2016/029551

§ 371 Date: Oct. 26, 2017

Related U.S. Application Data
(60) Provisional application No. 62/155,780, filed on May 1, 2015.

(51) Int. Cl. C09J 133/08; C08F 220/18

(52) U.S. Cl. CPC C09J 133/08; C08F 220/18; C09J 2433/00; C09J 2203/318; C09J 2205/114; C08F 2220/1891

(57) ABSTRACT

An optically clear adhesive composition is provided that is derived from precursors that include from about 0 to about 50 parts by weight of an alkyl acrylate having 1-11 carbon atoms in the alkyl group, from about 40 to about 95 parts by weight of an alkyl acrylate having 12 or more carbon atoms in the alkyl group, from about 5 to about 20 parts by weight of a copolymerizable polar monomer, and an initiator. The adhesive composition has a moisture content of less than about 1.0% when the adhesive is positioned in between two release films and placed in an environment of 85 C/85% relative humidity for 72 hours and then cooled down to room temperature. Moreover, when the adhesive composition is placed between two transparent substrates and made into a laminate, the laminate has a haze value of less than about 5% after the laminate is placed in an environment of 85 C/85% relative humidity for 72 hours and then cooled down to room temperature.

### FIELD OF THE INVENTION

The present invention relates generally to optically clear adhesives. In particular, the present invention relates to an optically clear adhesive composition that minimizes electrolytic migration in metallic conductors.

### BACKGROUND

Optically clear adhesives (OCAs) have wide applications in optical displays. Such applications include bonding polarizers to modules of a display panel and attaching various optical films to a glass lens in, for example, mobile hand held devices, tablets and laptops. During use, the display can be subjected to various environmental conditions, such as high temperature and/or high humidity and should be able to withstand such conditions.

OCAs are commonly used in touch screen systems and may be directly laminated to a bare (i.e. no protective overcoating is utilized) metallic conductor having transparent electrodes such as those including, for example, indium tin oxide (ITO), silver nanowires or metal mesh. However, one concern with ITO transparent electrodes is that they can have high electrical resistance issues in large sized touch applications. Thus, alternatives to ITO, such as silver nanowires and metal mesh, are currently in high demand because of their low resistance for large sized applications, flexible properties, and lower cost. While the non-ITO based conductors have lower resistance relative to ITO electrodes, the metal based materials are well known to be susceptible to electrochemical oxidation in the presence of an oxidant such as oxygen and moisture. The electrolytic migration between metal traces of the metallic conductors under current industry standards for flow and elevated temperature high humidity environments, i.e. 85° C. and 85% humidity, can cause discontinuity in the metallic conductor. Indeed, metallic migration between traces can cause so-called dendritic growth and bridging between traces, which eventually short the circuit.

### SUMMARY

In one embodiment, the present invention is an optically clear adhesive composition that is derived from precursors that include from about 0 to about 50 parts by weight of an alkyl acrylate having 1-11 carbon atoms in the alkyl group, from about 40 to about 95 parts by weight of an alkyl acrylate having 12 or more carbon atoms in the alkyl group, from about 5 to about 20 parts by weight of a copolymerizable polar monomer, and an initiator. The adhesive composition has a moisture content of less than about 1.0%. When the adhesive is positioned between two transparent substrates and made into a laminate, the laminate has a haze value of less than about 5% after the laminate is placed in an environment of 85° C./85% relative humidity for 72 hours and then cooled down to room temperature.

In another embodiment, the present invention is an optically clear laminate including a first substrate, a second substrate, and an optically clear adhesive composition positioned between the first substrate and the second substrate. The adhesive composition is prepared by polymerizing a precursor mixture including from about 0 to about 50 parts by weight of an alkyl acrylate having 1-11 carbon atoms in the alkyl group, from about 40 to about 95 parts by weight of an alkyl acrylate having 12 or more carbon atoms in the alkyl group, from about 5 to about 20 parts by weight of a copolymerizable polar monomer, and an initiator. The adhesive composition has a moisture content of less than about 1.0%. Moreover, when the adhesive composition is placed between two transparent substrates and made into a laminate, the laminate has a haze value of less than about 5% after the laminate is placed in an environment of 85° C./85% relative humidity for 72 hours and then cooled down to room temperature.

In yet another embodiment, the present invention is a method of minimizing electrolytic migration in an optically clear laminate. The method includes providing a first substantially transparent substrate, providing a second substantially transparent substrate, and laminating an optically clear adhesive between the first and second transparent substrates, wherein at least one of the substantially transparent substrates and the optically clear adhesive is in contact with a metallic conductor. The adhesive composition is prepared by polymerizing a precursor mixture. The precursor mixture includes from about 0 to about 50 parts by weight of an alkyl acrylate having 1-11 carbon atoms in the alkyl group, from about 40 to about 95 parts by weight of an alkyl acrylate having 12 or more carbon atoms in the alkyl group, from about 5 to about 20 parts by weight of a copolymerizable polar monomer, and an initiator. The adhesive composition has a moisture content of less than about 1.0%. Moreover, when the adhesive composition is placed between two transparent substrates and made into a laminate, the laminate has a haze value of less than about 5% after the laminate is placed in an environment of 85° C./85% relative humidity for 72 hours and then cooled down to room temperature.

### BRIEF DESCRIPTION OF THE DRAWINGS

FIG. 1 is a cross-sectional view of a first embodiment of a low moisture absorbing OCA of the present invention positioned within a laminate.

FIG. 2 is a cross-sectional view of a second embodiment of a low moisture absorbing OCA of the present invention positioned within a laminate.

FIG. 3 is a cross-sectional view of a metallic conductor positioned on a first substrate of the laminate of FIG. 1 and laminated to the low moisture absorbing OCA of the present invention.

FIG. 4A is a photograph of dendritic growth on a metallic conductor.

FIG. 4B is a photograph of dendritic growth on a metallic conductor.

### DETAILED DESCRIPTION

The low moisture absorbing optically clear adhesive (OCA) of the present invention maintains optical quality during durability testing, retaining high visible light transmission and low haze. When laminated to a metallic conductor, the low moisture absorbing OCA also minimizes or prevents electrochemical oxidation and electrolytic migration of metal and thus prevents the failure of metallic conductors made of metal, such as nanowires, metal meshes or metallic traces, which are in contact with the low moisture absorbing OCA. Even with low moisture absorption, the metallic conductor bonded with the low moisture absorbing OCA composition of the present invention retains its optical quality during durability testing.

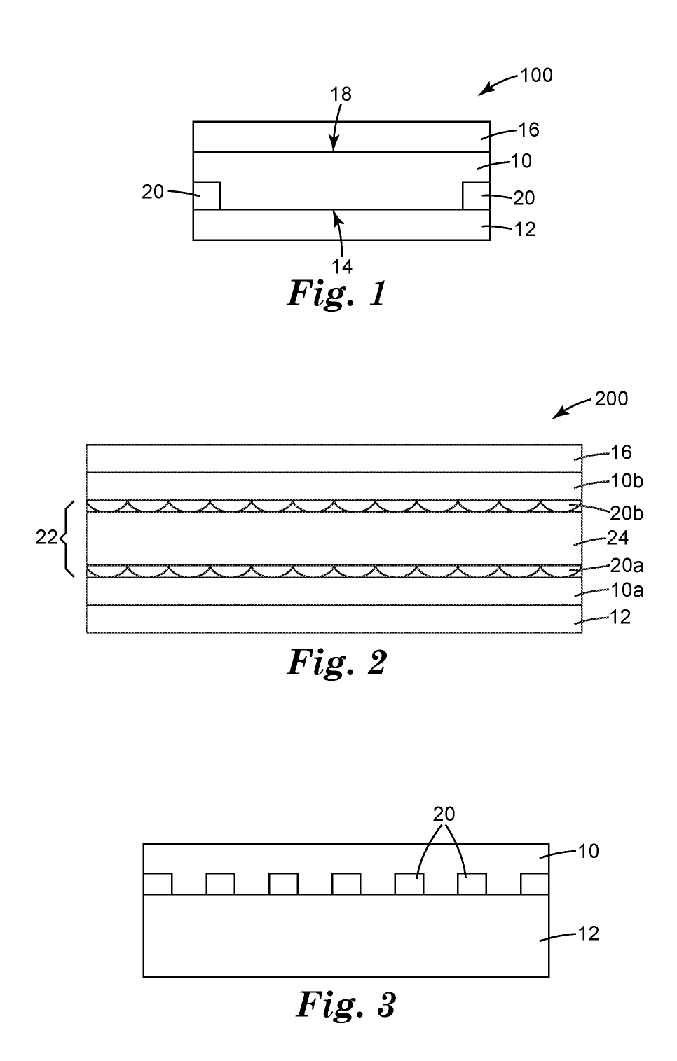

FIG. 1 is a cross-sectional view of a first embodiment of the low moisture absorbing optically clear adhesive (OCA) 10 of the present invention as part of a laminate 100. The laminate 100 is also optically clear and includes a first substrate 12 having at least one major surface 14, a second substrate 16 having at least one major surface 18, a metallic conductor 20, and the low moisture absorbing OCA 10. Although FIG. 1 depicts the laminate 100 as having one metallic conductor 20 and one low moisture absorbing OCA 10, the laminate 100 may include any number of metallic conductors and low moisture absorbing OCAs without departing from the intended scope of the present invention. As used herein, a laminate is defined as including at least a first substrate, a second substrate, and a low moisture absorbing OCA positioned between the first and second substrates. As used herein, the term “optically clear” refers to a material that has a luminous transmission of greater than about 90 percent, a haze of less than about 5 percent, and opacity of less than about 1 percent in the 400 to 700 nm wavelength range. Both the luminous transmission and the haze can be determined using, for example, ASTM-D 1003-95. Typically, the optically clear adhesives and laminates are visually free of bubbles.

The low moisture absorbing OCA can be used to create haze-free optical laminates that remain haze-free even after high temperature/humidity accelerated aging tests. In one embodiment, the low moisture absorbing OCA compositions are derived from precursors that include an alkyl acrylate having 1-11 carbon atoms in the alkyl group, an alkyl acrylate having 12 or more carbon atoms in the alkyl group, a copolymerizable polar monomer and an initiator. Examples of suitable alkyl acrylates having 1-11 carbon atoms in the alkyl group include, but are not limited to: isooctylacrylate, 2-ethylhexylacrylate, and butylacrylate. In one embodiment, the low moisture absorbing OCA composition includes up to about 50 parts by weight of alkyl acrylate having 1-11 carbon atoms in the alkyl group, particularly up to about 30 parts by weight of alkyl acrylate having 1-11 carbon atoms in the alkyl group, and more particularly up to about 15 parts by weight of alkyl acrylate having 1-11 carbon atoms in the alkyl group. In one embodiment, the low moisture absorbing OCA composition includes between more than 0 and about 50 parts by weight of alkyl acrylate having 1-11 carbon atoms in the alkyl group, particularly between more than 0 and about 30 parts by weight of alkyl acrylate having 1-11 carbon atoms in the alkyl group, and more particularly between more than 0 and about 15 parts by weight of alkyl acrylate having 1-11 carbon atoms in the alkyl group. In one embodiment, the low moisture absorbing OCA composition may not include any alkyl acrylate having 1-11 carbon atoms in the alkyl group.

Examples of suitable alkyl acrylates having 12 or more carbon atoms in the alkyl group include, but are not limited to: laurylacrylate, octadecylacrylate, tetradecylacrylate, isostearyl acrylate, and hexadecylacrylate. Additional examples of suitable alkyl acrylates having 12 or more carbon atoms in the alkyl group include those disclosed in U.S. Pat. No. 8,137,807, entitled “Pressure-Sensitive Adhesives Derived from 2-Alkyl Alkanols” and U.S. Patent Publication 2013/0260149, entitled “Polymers Derived from Secondary Alkyl (Meth)acrylates”, which are hereby incorporated by reference. In one embodiment, the low moisture absorbing OCA composition includes between about 40 and about 95 parts by weight of alkyl acrylate having 12 or more carbon atoms in the alkyl group, particularly between about 50 and about 95 parts by weight of alkyl acrylate having 12 or more carbon atoms in the alkyl group, and more particularly between about 60 and about 90 parts by weight of alkyl acrylate having 12 or more carbon atoms in the alkyl group.

Examples of suitable copolymerizable polar monomers include, but are not limited to: acrylamide, N-alkyl substituted acrylamide (such as N-octyl acrylamide), N,N-dialkyl substituted acrylamides (such as N,N-dimethyl acrylamide), N-vinyl lactams (such as N-vinyl pyrrolidone), and hydroxy functional (meth)acrylates (such a 2-hydroxy ethyl acrylate, 2-hydroxypropyl acrylate, hydroxybutyl acrylate, etc.). In one embodiment, the low moisture content OCA composition includes between about 5 and about 20 parts by weight of copolymerizable polar monomer, particularly between about 5 and about 15 parts by weight of copolymerizable polar monomer, and more particularly between about 8 and about 12 parts by weight of copolymerizable polar monomer.

In addition, the precursor mixture can include a thermal initiator or a photoinitiator. Examples of thermal initiators include peroxides such as benzoyl peroxide and its derivatives or azo compounds such as VAZO 67, available from E. I. du Pont de Nemours and Co. Wilmington, Del., which is 2,2′-azobis-(2-methylbutyronitrile), or V-601, available from Wako Specialty Chemicals, Richmond, Va., which is dimethyl-2,2′-azobisisobutyrate. A variety of peroxide or azo compounds are available that can be used to initiate thermal polymerization at a wide variety of temperatures. The precursor mixtures can include a photoinitiator. Particularly useful are initiators such as IRGACURE 651, available from Ciba Chemicals, Tarrytown, N.Y., which is 2,2-dimethoxy-2-phenylacetophenone. Typically, the crosslinker, if present, is added to the precursor mixtures in an amount of from about 0.05 parts by weight to about 5.00 parts by weight based upon the other constituents in the mixture. The initiators are typically added to the precursor mixtures in the amount of from 0.05 parts by weight to about 2 parts by weight. The precursor mixture can be polymerized and/or cross-linked using actinic radiation or heat to form the adhesive composition. In one embodiment, to minimize the risk of corrosion of the metallic conductor, the low moisture absorbing OCA is free of acid. However, the low moisture absorbing OCA composition may include substantially no acid. As used herein, the term “substantially no acid” refers to less than about 5 parts per hundred and particularly less than about 3 parts per hundred acid. An example of an acid that may be included in small amounts is acrylic acid.

The low moisture absorbing OCA compositions may have additional components added to the precursor mixture. For example, the mixture may include a multifunctional crosslinker. Such crosslinkers include thermal crosslinkers which are activated during the drying step of preparing solvent coated adhesives and crosslinkers that copolymerize during the polymerization step. Such thermal crosslinkers may include multifunctional isocyanates, aziridines, multifunctional (meth)acrylates, and epoxy compounds. Exemplary crosslinkers include difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany. Ultraviolet, or “UV”, activated crosslinkers can also be used to crosslink the pressure sensitive adhesive. Such UV crosslinkers may include benzophenones and 4-acryloxybenzophenones.

Other materials can be added to the precursor mixture for special purposes, provided that they do not significantly reduce the optical clarity of the pressure sensitive adhesive. Examples of suitable additives include, but are not limited to: oils, plasticizers, antioxidants, UV stabilizers, pigments, curing agents, polymer additives and combinations thereof.

The low moisture absorbing OCA is inherently tacky. If desired, tackifiers can be added to the precursor mixture before formation of the OCA. Useful tackifiers include, for example: rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Due to the polar nature of acrylics, the mechanism of metal electrochemical oxidation and the electrolytic migration under low current in a device, such as touch device, is highly water dependent. It is believed that the low moisture absorption of the OCA, combined with good flow and sealing of the traces of the metallic conductor can greatly reduce the effect of moisture on electrolytic migration. Thus, the optically clear adhesive composition has low moisture absorption. Low moisture absorption can be determined by Karl-Fischer titration. Karl-Fischer titration is a common method for measuring moisture content with high accuracy and precision. The optically clear adhesive composition has a moisture content of less than about 1.0% at ambient temperatures. In addition, in one embodiment, after the moisture absorbing OCA is positioned in between two substrates and placed in an environment of 85° C./85% relative humidity for 72 hours and then cooled down to room temperature, the moisture absorbing OCA has a moisture content of less than about 1.0%, particularly less than about 0.6% and more particularly less than about 0.2%. Thus, a laminate including the optically clear adhesive composition will also have a moisture content of less than about 1.0%, particularly less than about 0.6% and more particularly less than about 0.2% when placed in an environment of 85° C./85% relative humidity for 72 hours and then cooled down to room temperature.

The low moisture absorbing OCA may have a low or a high moisture vapor transmission rate (MVTR). The MVTR is a measure of the passage of water vapor through a substance. In one embodiment, the low moisture absorbing OCA has a low MVTR. In particular, the low moisture absorbing OCA has a MVTR of less than about 400 g/m²/day, particularly less than about 300 g/m²/day, and more particularly less than about 200 g/m²/day.

The precursors can be blended to form an optically clear mixture. The mixture can be polymerized by exposure to heat or actinic radiation (to decompose initiators in the mixture). This can be done prior to the addition of a cross-linker to form a coatable syrup to which, subsequently, one or more crosslinkers, and additional initiators can be added, the syrup can be coated on a liner, and cured (i.e., cross-linked) by an additional exposure to initiating conditions for the added initiators. Alternatively, the crosslinker and initiators can be added to the monomer mixture and the monomer mixture can be both polymerized and cured in one step. The desired coating viscosity can determine which procedure should be used. Examples of post-curable OCAs include those that have pendant (meth)acrylate groups, or use photo-crosslinkers such as those based on benzophenone, anthraquinone, and the like.

The low moisture absorbing optically clear adhesive composition can be applied as either a cured film or curable liquid. When coated, the low moisture absorbing OCA is coated by any variety of known coating techniques, such as roll coating, spray coating, knife coating, die coating, and the like. Alternatively, the precursor mixture may also be delivered as a liquid to fill the gap between the two substrates and subsequently be exposed to heat or UV to polymerize and cure the composition. While the liquid form is always cured after application, the film adhesives may or not be curable after lamination.

Curing may be done by any means known in the art. Typically, the initiator or initiators in the OCA composition are activated by exposure to light of the appropriate wavelength and intensity. Often UV light is used. However, any method, including, but not limited to, thermal or radiation curing, may be used.

The present invention also provides laminates having at least one of the following properties: the low moisture absorbing OCA has optical transmissivity over a useful lifetime of the article, the low moisture absorbing OCA can maintain a sufficient bond strength between layers of the article, the low moisture absorbing OCA can resist or avoid delamination, and the low moisture absorbing OCA can resist bubbling over a useful lifetime. The resistance to bubble formation and retention of optical transmissivity can be evaluated using accelerated aging tests. In an accelerated aging test, the low moisture absorbing OCA is positioned between two substrates. The resulting laminate is then exposed to elevated temperatures combined with elevated humidity for a period of time. Even after exposure to elevated temperature and humidity, the low moisture absorbing OCA and, correspondingly, the laminate, will retain optical clarity. For example, the low moisture absorbing OCA and laminate remain optically clear after aging at 85° C. and 85% relative humidity for approximately 72 hours and subsequently cooling to room temperature. After aging, the average transmission of the adhesive between 450 nanometers (nm) and 650 nm is greater than about 85 percent and the haze is less than about 5% and particularly less than about 2%.

The laminates include an optical film or substantially optically clear substrate and the low moisture absorbing OCA positioned adjacent to at least one major surface of the optical film or substrate. The low moisture absorbing OCA is in contact with the metallic conductor. The laminates can further include another substrate (e.g., permanently or temporarily attached to the pressure sensitive adhesive layer), another adhesive layer, or a combination thereof. As used herein, the term “adjacent” can be used to refer to two layers that are in direct contact or that are separated by one or more thin layers, such as primer or hard coating. Often, adjacent layers are in direct contact. Additionally, laminates are provided that include the low moisture absorbing OCA positioned between two substrates, wherein at least one of the substrates is an optical film. Optical films intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel, electrowetting display or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, cyclic olefin copolymers, polypropylenes, and cellulose triacetates. Typically, cover lenses can be made of glass, polymethyl methacrylates, polycarbonates or polyesters.

In other embodiments, the substrate can be a release liner. Any suitable release liner can be used. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film.

The low moisture absorbing OCA composition of the present disclosure may be applied directly to one or both sides of an optical element such as a polarizer. The polarizer may include additional layers such as an anti-glare layer, a protective layer, a reflective layer, a phase retardation layer, a wide-angle compensation layer, and a brightness enhancing layer. In some embodiments, the low moisture absorbing OCA composition may be applied to one or both sides of a liquid crystal cell. It may also be used to adhere a polarizer to a liquid crystal cell. Yet another exemplary set of optical laminates include the application of a cover lens to a LCD panel, the application of a touch panel to an LCD panel, the application of a cover lens to a touch panel, or combinations thereof.

The low moisture absorbing OCA composition can particularly be used with a touch panel, as shown in the second embodiment of FIG. 2. A touch panel is a transparent thin film-shaped device. When a user touches or presses a position on the touch panel with a finger or a pen, the position can be detected and specified. Touch-sensitive optical assemblies (touch-sensitive panels) can include capacitive sensors, resistive sensors, and projected capacitive sensors. Such metallic conductors include transparent conductive elements on substantially transparent substrates that overlay the display. In the second embodiment shown in FIG. 2, the laminate 200 includes a first substrate 12, a first low moisture absorbing OCA 10a, a touch panel 22, a second low moisture absorbing OCA 10b and a second substrate 16. The touch panel 22 includes a film 24 having a first metallic conductor 20a and a second metallic conductor 20b on either major surface of the film 24.

FIG. 3 shows a cross sectional view of the metallic conductor 20 on the first substrate 12 and laminated to the low moisture absorbing OCA 10. The metallic conductor 20 may be an electro-conducting sensor or trace. The metallic conductor can be derived from metallic oxide, such as indium tin oxide or a conductive metal. The metallic conductor 20 can include, for example: nanowires, metal meshes or metal mesh transparent conductors. Examples of suitable metals include silver, silver halide and copper. The metal surface of the metal mesh or nanowire transparent conductor is directly laminated with the low moisture absorbing OCA to help the metallic conductor survive in elevated temperatures and humidity. The thickness of the metal trace of a metal mesh electrode is usually larger (sub-micron) than indium tin oxide (hundreds angstrom) due to the manufacturing process i.e. relief printing process. The void space after etching is thus larger than when an ITO electrode is used as the metallic conductor. As can be imagined, there may be a void space between the metal traces. The haze level generally increases after exposure to elevated temperature and humidity. Without being bound by theory, this increase may be due to water condensation droplets in the void space. The low moisture absorbing and soft OCA of the present invention can prevent this issue. In particular, a low moisture absorbing OCA with high conformability to the individual traces can be used to eliminate the void space. In addition, if the void space is filled with the low moisture absorbing OCA, moisture ingress by capillary action is also eliminated. Therefore, the low moisture absorbing OCA covers enough surface area between the metal traces to prevent water from wicking in and potentially corroding the metal.

The low moisture absorbing OCA desirably maintains optical clarity, bond strength, and resistance to delamination over the lifetime of the article in which it is used. The low moisture absorbing OCA is also used to minimize or prevent the electrolytic migration of traces of a metallic conductor made of metal in an optically clear laminate. In practice, the metallic conductor is laminated with the low moisture absorbing OCA between a first substantially transparent substrate and a second substantially transparent substrate or to one of the substrates. The low moisture absorbing OCA may be cured at any time during or after deposition of the low moisture absorbing OCA onto the metallic conductor and between the substantially transparent substrates. The laminate created by the first and second substrates, the metallic conductor and the low moisture absorbing OCA remains optically clear even after exposure to high temperatures and humidity and subsequent cooling to room temperature. In one embodiment, the laminate has a haze value of 5% of less and particularly 2% or less, after being exposed to 85° C./85% relative humidity for a period of 72 hours and humidity and subsequent cooling to room temperature.

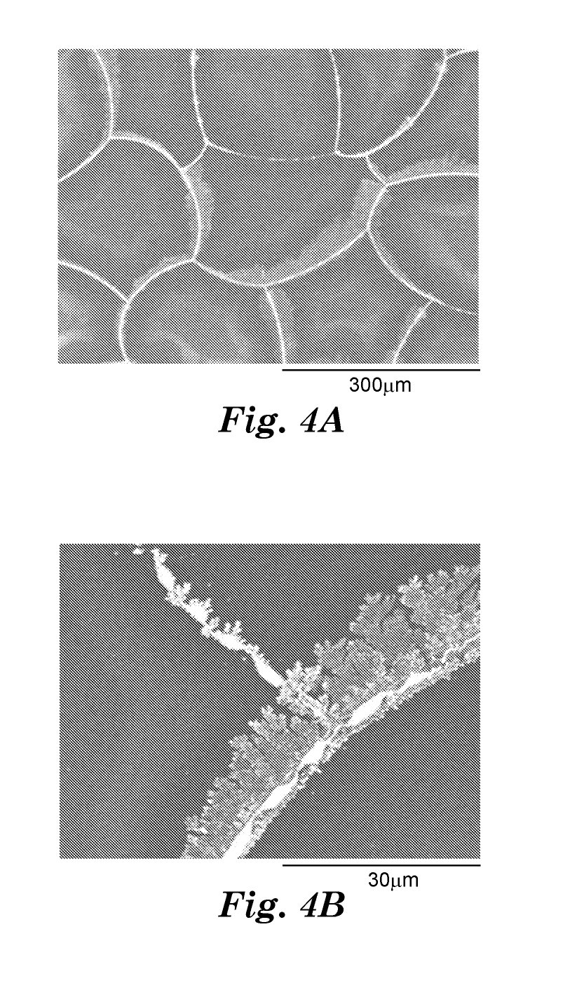

In addition, even after exposure to high heat and humidity, there is minimal to no electrolytic migration of the traces of the metallic conductor. Electrolytic migration can be observed by yellowing of the laminate caused by corrosion of the metallic conductor or even shorting of the circuit. Electrolytic migration can also be observed by examining whether there is any dendritic growth from the metallic conductor, as viewed under a microscope at ten (10) times magnification. Dendritic growth can be seen, for example, in FIGS. 4A and 4B. When the low moisture absorbing OCA is placed between two transparent substrates and made into a laminate, wherein at least one of the transparent substrates is coated with a metallic conductor, the laminate has substantially no dendritic growth when observed under a microscope at a magnification of 10 times after the laminate is placed in an environment of 85° C./85% relative humidity for 72 hours and an electric current is maintained through the metallic conductor.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

Although the present invention has been described with reference to preferred embodiments, workers skilled in the art will recognize that changes may be made in form and detail without departing from the spirit and scope of the invention.

TABLE 1
Materials

| | Trade name or | |
|---|---|---|
| Material | Abbreviation | Source |
| 2-Ethylhexyl acrylate | EHA | BASF Corporation, |
| | | Florham Park, NJ |
| Isobornyl acrylate | iBOA | BASF Corporation, |
| | | Florham Park, NJ |
| 2-Hydroxyethyl acrylate | HEA | BASF Corporation, |
| | | Florham Park, NJ |
| Isostearyl acrylate | ISTA | Shin-Nakamura |
| | | Chemical Co., Ltd |
| 2-Hydroxypropyl acrylate | HPA | BASF Corporation, |
| | | Florham Park, NJ |
| 2-Ethylhexyl methacrylate | EHMA | BASF Corporation, |
| | | Florham Park, NJ |
| 1,6-Hexanediol diacrylate | HDDA | Sigma-Aldrich Co., |
| | | St. Louis, MO |
| 2,2-Dimethoxy-1,2- | Irgacure 651 | BASF Corporation, |
| dipheylethan-1-one | (Irg651) | Florham Park, NJ |

### Test Methods

### Water Content

A sample of adhesive (100 microns thick, 3 inch length by 3 inch width) laminated between two silicone-coated polyethylene terephthalate (PET) films (SKC Haas RFO2N and RF22N, the thickness of each film was 75 microns) was placed in an 85% relative humidity environment at 85° C. for 72 hours. Afterwards, the silicone-coated PET films were removed and the adhesive was placed in a dry container and immersed in a known amount of anhydrous methanol for 24 hours. The water content was then measured by Karl Fischer titration of the methanol solution using a Karl Fischer Coulometer, available from Metrohm USA, Riverview, Fla.. Refer to Metrohm Application Bulletin 137e for additional test information regarding the Karl Fischer titration.

### Haze Measurement

Laminates were prepared by bonding a 125 μm trick polyester film (MELINEX 617, available from DuPont Company, Wilmington, Del.) to a float glass plate using the OCA (100 μm thickness). The laminates were placed in an oven set at 85° C./85% relative humidity (RH). After 72 hours, the laminates were taken out of the oven, cooled down to room temperature, and visually observed. In addition to the visual observation, the percent transmission and percent haze measurements can be made using, for example, the Byk-Gardner TCS Plus spectrophotometer (Byk-Gardner GMBH, Geretsried, Germany). In this test, the same optical laminate described above is used. During the test, the background was determined using the PET and glass only and this background value was subtracted from the value of the OCA-containing laminate. Thus, the reported values are for the adhesive only. The adhesives of this disclosure typically show less than 5% haze and preferably less than 2% haze after exposure to elevated temperature and humidity. In the haze test, “clear” means a haze value below 2%.

### Example 1

A monomer premix was prepared using 2-ethylhexyl acrylate (EHA) (15 parts by weight), isostearyl acrylate (ISTA) (65 parts by weight), 2-hydroxypropyl acrylate (HPA) (20 parts by weight), and 0.01 parts by weight 2,2-dimethoxy-2-phenylacetophenone photoinitiator (Irgacure 651, available from BASF Corporation, Florham Park, N.J.). This mixture was partially polymerized under a nitrogen-rich atmosphere by exposure to ultraviolet radiation to provide a coatable syrup having a viscosity of about 2000 cps. Then 0.12 parts by weight of 1,6-hexanediol diacrylate (HDDA) and an additional 0.14 parts by weight of Irgacure 651 were added to the syrup and it was then knife coated between two silicone-treated polyethylene terephthalate (PET) release liners at a thickness of 100 microns. The resulting composite was then exposed to ultraviolet radiation (a total energy of 2,000 mJ/cm²) having a spectral output from 300-400 nm with a maximum at 351 nm. The materials used in this and the other examples are summarized in Table 2.

### Example 2

Example 2 was made using a procedure similar to that of Example 1, except 2-ethylhexyl acrylate (EHA) (10 parts by weight), isostearyl acrylate (ISTA) (68 parts by weight), 2-ethylhexyl methacrylate (EHMA) (12 parts by weight), 2-hydroxyethyl acrylate (HEA) (10 parts by weight), 1,6-hexanediol diacrylate (HDDA) (0.15 parts by weight), and 2,2-dimethoxy-2-phenylacetophenone photoinitiator (Irgacure 651) (0.20 parts by weight in total) were used.

### Comparative Example 1

Comparative Example 1 was made using a procedure similar to that of Example 1, except 2-ethylhexyl acrylate (EHA) (45 parts by weight), isobornyl acrylate (iBOA) (25 parts by weight), 2-hydroxyethyl acrylate (HEA) (20 parts by weight), 1,6-hexanediol diacrylate (HDDA) (0.15 parts by weight), and 2,2-dimethoxy-2-phenylacetophenone photoinitiator (Irgacure 651) (0.15 parts by weight in total) were used.

TABLE 2
Components of Examples and Comparative Example
reported as weight percent of each formulation.

| | EHA | ISTA | iBOA | EHMA | HEA | HPA | HDDA | Irg651 |
|---|---|---|---|---|---|---|---|---|
| Exam- | 15 | 65 | | | | 20 | 0.12 | 0.15 |
| ple 1 | | | | | | | | |
| Exam- | 10 | 68 | | 12 | 10 | | 0.15 | 0.20 |
| ple 2 | | | | | | | | |
| Com- | 55 | | 25 | | 20 | | 0.15 | 0.15 |
| parative | | | | | | | | |
| Exam- | | | | | | | | |
| ple 1 | | | | | | | | |

TABLE 3
Weight percent water content of different samples after exposure
to 85% relative humidity and 85° C. temperature for three days.

| | wt % Water Content | Haze Observation |
|---|---|---|
| Example 1 | 0.86 | clear |
| Example 2 | 0.34 | clear |
| Comparative | 1.07 | clear |
| Example 1 | | |

As can be seen from Table 3, the incorporation of greater than 40 parts by weight of an alkyl acrylate having 12 or more carbon atoms in the alkyl group (e.g., isostearyl acrylate) leads to decreased water absorption in the adhesive (moisture content less than about 1.0% after exposure to an 85% relative humidity environment at 85° C. for 72 hours and subsequent cooling to room temperature). Additionally, the presence of a copolymerizable polar monomer helped to maintain the optical clarity of the laminate.

What is claimed is:

1. An optically clear adhesive composition that is derived from precursors that comprise:
from about 0 to about 50 parts by weight of an alkyl acrylate having 1-11 carbon atoms in the alkyl group;
from about 40 to about 95 parts by weight of an alkyl acrylate having 12 or more carbon atoms in the alkyl group;
from about 5 to about 20 parts by weight of a copolymerizable polar monomer; and
an initiator,
wherein the adhesive composition has a moisture content of less than about 1.0%, and
wherein when the adhesive composition is placed between two transparent substrates and made into a laminate, the laminate has a haze value of less than about 5% after the laminate is placed in an environment of 85° C./85% relative humidity for 72 hours.

2. The optically clear adhesive composition of claim 1, wherein when the adhesive composition is placed between two transparent substrates and made into a laminate and wherein at least one of the transparent substrates and the adhesive composition is coated with a metallic conductor, the laminate has substantially no dendritic growth when observed under a microscope at a magnification of 10 times after the laminate is placed in an environment of 85° C./85% relative humidity for 72 hours and an electric current is maintained through the metallic conductor.

3. The optically clear adhesive composition of claim 1, wherein the alkyl acrylate having 12 or more carbon atoms in the alkyl group is branched.

4. The optically clear adhesive composition of claim 1, wherein the adhesive composition is one of a film or a liquid.

5. An optically clear laminate comprising:
a first substrate;
a second substrate; and
an optically clear adhesive composition positioned between the first substrate and the second substrate, wherein the adhesive composition is prepared by polymerizing a precursor mixture, the precursor mixture comprising:
from about 0 to about 50 parts by weight of an alkyl acrylate having 1-11 carbon atoms in the alkyl group;
from about 40 to about 95 parts by weight of an alkyl acrylate having 12 or more carbon atoms in the alkyl group;
from about 5 to about 20 parts by weight of a copolymerizable polar monomer; and
an initiator,
wherein the adhesive composition has a moisture content of less than about 1.0%, and
wherein the laminate has a haze value of less than about 5% after the laminate is placed in an environment of 85° C./85% relative humidity for 72 hours.

6. The optically clear laminate of claim 5, wherein the laminate further comprises a metallic conductor.

7. The optically clear laminate of claim 6, wherein the metallic conductor is derived from a metallic oxide or a conductive metal.

8. The optically clear laminate of claim 7, wherein the metallic oxide is indium tin oxide.

9. The optically clear laminate of claim 6, wherein the laminate containing a metallic conductor has substantially no dendritic growth when observed under a microscope at a magnification of 10 times after the laminate is placed in an environment of 85° C./85% relative humidity for 72 hours and an electrical current is maintained through the metallic conductor.

10. The optically clear laminate of claim 6, wherein the metallic conductor is selected from one of a nanowire, a metal mesh or a metal trace.

11. The optically clear laminate according to claim 5, wherein at least one of the first substrate and the second substrate are selected from a display panel, a touch panel, an optical film, a cover lens or a window.

12. The optically clear laminate according to claim 11, wherein the display panel is selected from a liquid crystal display, a plasma display, an OLED display, an electrowetting display, and a cathode ray tube display.

13. The optically clear laminate according to claim 11, wherein the optical film is selected from a reflector, a polarizer, a mirror, an anti-glare or anti-reflective film, an anti-splinter film, a diffuser or electromagnetic interference filter.

14. The optically clear laminate according to claim 11, wherein the cover lens is selected from glass, polymethylmethacrylate, polycarbonate or polyester.

15. The optically clear laminate of claim 5, wherein the alkyl acrylate having 12 or more carbon atoms in the alkyl group is branched.

16. A method of minimizing electrolytic migration in an optically clear laminate comprising:
providing a first substantially transparent substrate;
providing a second substantially transparent substrate; and
laminating an optically clear adhesive between the first and the second transparent substrates, wherein at least one of the substantially transparent substrates and the optically clear adhesive is in contact with a metallic conductor, wherein the optically clear adhesive composition is prepared by polymerizing a precursor mixture, the precursor mixture comprising:
from about 0 to about 50 parts by weight of an alkyl acrylate having 1-11 carbon atoms in the alkyl group;
from about 40 to about 95 parts by weight of an alkyl acrylate having 12 or more carbon atoms in the alkyl group;
from about 5 to about 20 parts by weight of a copolymerizable polar monomer; and
an initiator,
wherein the adhesive composition has a moisture content of less than about 1.0%, and
wherein the laminate has a haze value of less than about 5% after the laminate is placed in an environment of 85° C./85% relative humidity for 72 hours.

17. The method of claim 16, wherein the laminate has substantially no dendritic growth when observed under a microscope at a magnification of 10 times after the laminate is placed in an environment of 85° C./85% relative humidity for 72 hours and an electrical current is maintained through the metallic conductor.

18. The method of claim 16, wherein the metallic conductor is selected from one of a nanowire, a metal mesh or a metallic trace.

19. The method of claim 16, wherein the alkyl acrylate having 12 or more carbon atoms in the alkyl group is branched.
